(19) United States
(12) Patent Application Publication
(10) Pub. No.: US 2025/0277422 A1
(43) Pub. Date: Sep. 4, 2025

(54) SEAL, METHOD, AND SYSTEM

(71) Applicant: Baker Hughes Oilfield Operations LLC, Houston, TX (US)

(72) Inventors: Joseph Ramirez, Houston, TX (US); Stephen Zamora, Pearland, TX (US)

(21) Appl. No.: 18/594,602

(22) Filed: Mar. 4, 2024

(51) Int. Cl. E21B 33/12; F16J 15/32

(52) U.S. Cl. CPC E21B 33/12; F16J 15/32

(57) ABSTRACT

A seal, including an element, a groove in the element, a ring disposed in the groove, and a backup in contact with the element inboard of the ring when the seal is in a preset condition. A packer system including the above elements. A method for resisting swab off of an element, including configuring an element with a groove therein, disposing a ring in the groove, and disposing a backup adjacent the element with a portion of the backup extending radially outwardly of the ring and contacting the element inboard of the ring in a preset condition. A wellbore system, including a borehole in a subsurface formation, a string in the borehole, and a seal, disposed within or as a part of the string. A seal, including an element, a groove in the element, a backup having an anchor depending therefore, the anchor in contact with the element.

### BACKGROUND

In the resource recovery and fluid sequestration industries seals are often used. It is a fact that flow rates in an annular space radially outwardly of such seals pose a risk to the seal in the form of swabbing (sucking the seal into the annular space to sometimes cause early setting or sometimes causing a loss of the seal entirely. Accordingly, flow rates must be carefully monitored and controlled to avoid untoward occurrences with seals employed in the system. The ability to flow at higher rates then sometimes afforded is also of interest to the industry and hence the industry is always receptive to new technology that facilitates greater latitude with operating parameters.

### SUMMARY

An embodiment of a seal, including an element, a groove in the element, a ring disposed in the groove, and a backup in contact with the element inboard of the ring when the seal is in a preset condition.

An embodiment of a packer system including a mandrel, an element disposed radially outwardly of the mandrel, a groove in the element, a ring in the groove, and a backup extending radially outwardly of the ring from an end of the element and into contact with the element inboard of the ring.

An embodiment of a method for resisting swab off of an element, including configuring an element with a groove therein, disposing a ring in the groove, and disposing a backup adjacent the element with a portion of the backup extending radially outwardly of the ring and contacting the element inboard of the ring in a preset condition.

An embodiment of a wellbore system, including a borehole in a subsurface formation, a string in the borehole, and a seal, disposed within or as a part of the string.

An embodiment of a seal, including an element, a groove in the element, a backup having an anchor depending therefore, the anchor in contact with the element.

### BRIEF DESCRIPTION OF THE DRAWINGS

The following descriptions should not be considered limiting in any way. With reference to the accompanying drawings, like elements are numbered alike:

FIG. 1 is a sectional view of a seal as disclosed herein in a preset or running condition;

FIG. 2 is the seal of FIG. 1 in a set condition;

FIG. 3 is a sectional view of an alternate embodiment of the seal disclosed herein; and

FIG. 4 is a view of a borehole system including a seal as disclosed herein.

### DETAILED DESCRIPTION

A detailed description of one or more embodiments of the disclosed apparatus and method are presented herein by way of exemplification and not limitation with reference to the Figures.

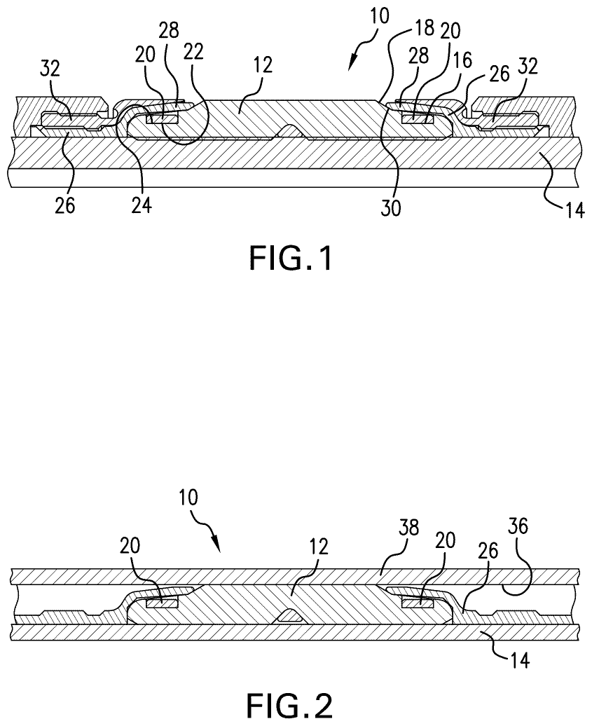

Referring to FIG. 1, a seal 10 is illustrated in cross section. Seal 10 includes an element 12 that is disposed radially outwardly of a mandrel 14. The element 12 includes a groove 16 extending radially inwardly from an outside surface 18 of the element 12. A ring 20 is disposed in the groove 16. The ring 20, in an embodiment, may have an inside diameter surface 22 that is smaller than an outside diameter surface 24 of the groove 16 resulting in compression radially inwardly of the element 12. The smaller diameter may be in a range of about 0.01 to about 0.05 inch. Adjacent the element 12 is a backup 26. Backup 26 is disposed on the mandrel 14 with a portion 28 thereof that extends radially outwardly of the groove 16 and into contact with the element 12 inboard of the groove 16 or ring 20. Stated alternately, a tip 30 of the backup 26 is in contact with the outside surface 18 of element 12. In embodiments, the seal 10 may also include a second backup 32 adjacent the backup 26. In embodiments, the groove, ring and backup configuration described above will be included on both longitudinal ends of the seal 10, as is illustrated.

Referring to FIG. 2, the embodiment illustrated in FIG. 1 is depicted in a post set condition. It will be appreciated that the element 12 has come into contact with an inside diameter surface 36 of another structure 38 to the outside thereof radially. Such structure 38 may be a casing or tubular or open hole in embodiments. The tip 30 is still in contact with surface 18 of element 12.

The ring 20 may comprise a plastic or metal material with greater stiffness of the material of the ring 20 being proportionally related to the annular fluid flow rate that can be resisted by the seal 10. Radial thickness of ring 20 may be in a range of about 0.030 inch to about 0.250 inch. Annular flow rate resistance is a direct effect of holding the element 12 down so it cannot billow up due to the Bernoulli effect of the flowing fluid.

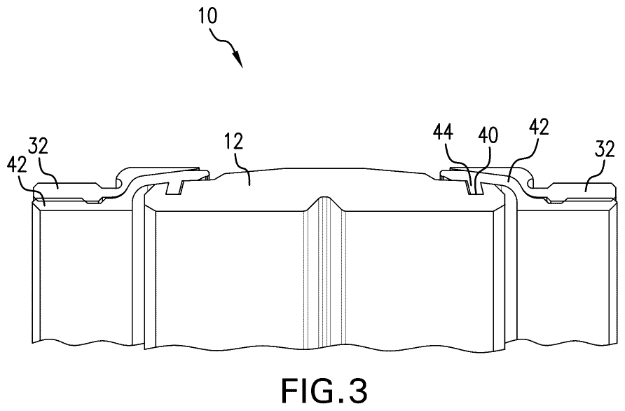

Referring to FIG. 3, an alternate embodiment of seal 10 is illustrated. It will be appreciated that the element 12 still has a groove 40 but that groove is angularly disposed in the element as shown. Another difference is that a backup 42 includes a depending anchor 44 that acts to replace the ring 20 of the previous embodiment. Anchor 44 depends from backup 42 at an angle as illustrated that supports the transmission of a tensile load to the element 12 through a tensile moment applied to the backups 42. The tensile load helps to retain the element 12 and avoid lift introduced by fluid flowing thereover. In all other respects, this embodiment is the same as the FIG. 1 embodiment and has the same ranges contemplated.

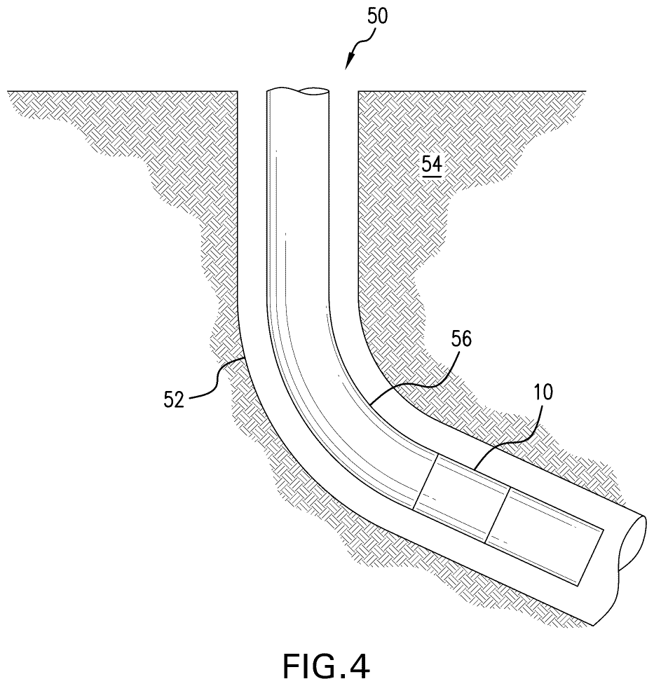

Referring to FIG. 4, a borehole system 50 is illustrated. The system 50 comprises a borehole 52 in a subsurface formation 54. A string 56 is disposed within the borehole 52. A seal 10 as disclosed herein is disposed within or as a part of the string 56.

Set forth below are some embodiments of the foregoing disclosure:

Embodiment 1: A seal, including an element, a groove in the element, a ring disposed in the groove, and a backup in contact with the element inboard of the ring when the seal is in a preset condition.

Embodiment 2: The seal as in any prior embodiment, wherein the backup is in contact with the element inboard of the ring when the seal is in a set condition.

Embodiment 3: The seal as in any prior embodiment, wherein the ring is more resistant to hoop stress than the backup.

Embodiment 4: The seal as in any prior embodiment, wherein the ring has an inside diameter dimension that is smaller than an outside diameter dimension of a ring contact surface of the groove.

Embodiment 5: The seal as in any prior embodiment, wherein the ring inside diameter dimension is in a range of about 1% about 5% smaller than the outside diameter dimension of the ring contact surface.

Embodiment 6: The seal as in any prior embodiment, wherein the ring is dimensioned to cause the element to be in contact with a mandrel radially inwardly located to the element.

Embodiment 7: The seal as in any prior embodiment, wherein the contact is loaded contact to cause a squeeze of the element against the mandrel to about 5% to about 20% of element unloaded radial dimension.

Embodiment 8: The seal as in any prior embodiment, wherein the ring is a polymeric material.

Embodiment 9: The seal as in any prior embodiment, wherein the ring is a metallic material.

Embodiment 10: A packer system including a mandrel, an element disposed radially outwardly of the mandrel, a groove in the element, a ring in the groove, and a backup extending radially outwardly of the ring from an end of the element and into contact with the element inboard of the ring.

Embodiment 11: The system as in any prior embodiment, wherein the backup includes a first backup ring and a second backup ring.

Embodiment 12: A method for resisting swab off of an element, including configuring an element with a groove therein, disposing a ring in the groove, and disposing a backup adjacent the element with a portion of the backup extending radially outwardly of the ring and contacting the element inboard of the ring in a preset condition.

Embodiment 13: The method as in any prior embodiment, wherein the method includes maintaining the contact between the backup and the element inboard of the ring in a post set condition.

Embodiment 14: The method as in any prior embodiment, wherein the disposing the ring includes compressing the element radially inwardly with the ring.

Embodiment 15: A wellbore system, including a borehole in a subsurface formation, a string in the borehole, and a seal as in any prior embodiment, disposed within or as a part of the string.

Embodiment 16: A seal, including an element, a groove in the element, a backup having an anchor depending therefore, the anchor in contact with the element.

Embodiment 17: The seal as in any prior embodiment, wherein the anchor is angled relative to the backup such that the anchor supports transmission of a tensile load to the element from the backup.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% of a given value.

The teachings of the present disclosure may be used in a variety of well operations. These operations may involve using one or more treatment agents to treat a formation, the fluids resident in a formation, a borehole, and/or equipment in the borehole, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A seal, comprising:
an element;
a groove in the element;
a ring disposed in the groove; and
a backup in contact with the element inboard of the ring when the seal is in a preset condition.

2. The seal as claimed in claim 1, wherein the backup is in contact with the element inboard of the ring when the seal is in a set condition.

3. The seal as claimed in claim 1, wherein the ring is more resistant to hoop stress than the backup.

4. The seal as claimed in claim 1, wherein the ring has an inside diameter dimension that is smaller than an outside diameter dimension of a ring contact surface of the groove.

5. The seal as claimed in claim 4, wherein the ring inside diameter dimension is in a range of about 1% about 5% smaller than the outside diameter dimension of the ring contact surface.

6. The seal as claimed in claim 1, wherein the ring is dimensioned to cause the element to be in contact with a mandrel radially inwardly located to the element.

7. The seal as claimed in claim 6, wherein the contact is loaded contact to cause a squeeze of the element against the mandrel to about 5% to about 20% of element unloaded radial dimension.

8. The seal as claimed in claim 1, wherein the ring is a polymeric material.

9. The seal as claimed in claim 1, wherein the ring is a metallic material.

10. A packer system comprising:
a mandrel;
an element disposed radially outwardly of the mandrel;
a groove in the element;
a ring in the groove; and
a backup extending radially outwardly of the ring from an end of the element and into contact with the element inboard of the ring.

11. The system as claimed in claim 10, wherein the backup includes a first backup ring and a second backup ring.

12. A method for resisting swab off of an element, comprising:
configuring an element with a groove therein;
disposing a ring in the groove; and
disposing a backup adjacent the element with a portion of the backup extending radially outwardly of the ring and contacting the element inboard of the ring in a preset condition.

13. The method as claimed in claim 12, wherein the method includes maintaining the contact between the backup and the element inboard of the ring in a post set condition.

14. The method as claimed in claim 12, wherein the disposing the ring includes compressing the element radially inwardly with the ring.

15. A wellbore system, comprising:
a borehole in a subsurface formation;
a string in the borehole; and
a seal as claimed in claim 1, disposed within or as a part of the string.

16. A seal, comprising:
an element;
a groove in the element;
a backup having an anchor depending therefore, the anchor in contact with the element.

17. The seal as claimed in claim 16, wherein the anchor is angled relative to the backup such that the anchor supports transmission of a tensile load to the element from the backup.
